(19) United States
(12) Patent Application Publication
(10) Pub. No.: US 2019/0272085 A1
(43) Pub. Date: Sep. 5, 2019

(54) Flexible Communication Account Workspace

(71) Applicant: Microsoft Technology Licensing,LLC, Redmond, WA (US)

(72) Inventor: Sivaprasad Radhakrishnan Lakshmi, Redmond, WA (US)

(21) Appl. No.: 15/910,432

(22) Filed: Mar. 2, 2018

(51) Int. Cl. G06F 3/0484; H04L 12/58; G06F 3/0481; G06F 3/0486; G06F 3/0482

(52) U.S. Cl. CPC G06F 3/04847; H04L 51/36; G06Q 10/107; G06F 3/0486; G06F 3/0482; G06F 3/04817

(57) ABSTRACT

A method of managing communication accounts includes receiving an indication identifying a first workspace from multiple workspaces, wherein each workspace is associated with at least one communication account selected from multiple accounts associated with at least one of multiple communication clients, retrieving information from multiple communication accounts associated with the first workspace, aggregating the information from the multiple communication accounts into a unified view, and causing display of the unified view.

### BACKGROUND

Current email clients may provide email services for multiple accounts for a single user. In addition, users may have multiple different email clients, each with one or more accounts for different purposes. Some accounts may be personal accounts. Some personal accounts may be used for different hobbies. Other accounts may be work related. Different work accounts may be used for different clients, or for different responsibilities at work, such as different products or different roles or jobs within a work environment. It becomes very difficult to effectively manage and switch between different email accounts and clients. Combining accounts and/or clients can be confusing and unproductive.

### SUMMARY

A method of managing communication accounts includes receiving an indication identifying a first workspace from multiple workspaces, wherein each workspace is associated with at least one communication account selected from multiple accounts associated with at least one of multiple communication clients, retrieving information from multiple communication accounts associated with the first workspace, aggregating the information from the multiple communication accounts into a unified view, and causing display of the unified view.

A machine-readable storage device has instructions for execution by a processor of a machine to cause the processor to perform operations to perform a method of managing communication accounts. The operations include receiving an indication identifying a first workspace from multiple workspaces, wherein each workspace is associated with at least one communication account selected from multiple accounts associated with at least one of multiple communication clients, retrieving information from multiple communication accounts associated with the first workspace, aggregating the information from the multiple communication accounts into a unified view, and causing display of the unified view.

A device includes a processor and a memory device coupled to the processor and having a program stored thereon for execution by the processor to perform operations including receiving an indication identifying a first workspace from multiple workspaces, wherein each workspace is associated with at least one communication account selected from multiple accounts associated with at least one of multiple communication clients, retrieving information from multiple communication accounts associated with the first workspace, aggregating the information from the multiple communication accounts into a unified view, and causing display of the unified view.

### BRIEF DESCRIPTION OF THE DRAWINGS

FIG. 1 is a block diagram logical representation of one or more workspace management tables according to an example embodiment.

FIG. 2 is a representation of an example user interface illustrating features of the workspace management system according to an example embodiment.

FIG, 3 is a flowchart illustrating a computer implemented method of displaying a selected workspace according to an example embodiment.

FIG. 4 at illustrates a method of adding a new account to a workspace in an open new account user interface according to an example embodiment.

FIG. 5 is a representation of a workspace bar with an added workspace according to an example embodiment.

FIG. 6 is a flowchart illustrating a method of creating a new workspace according to an example embodiment.

FIG. 7 is a graphical representation of a user interface for moving accounts between workspaces according to an example embodiment.

FIG. 8 illustrates an interface for use in modifying the name and appearance of a workspace icon according to an example embodiment.

FIG. 9 is a block schematic diagram of a computer system to implement and manage the use of flexible workspaces according to an example embodiment.

### DETAILED DESCRIPTION

In the following description, reference is made to the accompanying drawings that form a part hereof, and in which is shown by way of illustration specific embodiments which may be practiced. These embodiments are described in sufficient detail to enable those skilled in the art to practice the invention, and it is to be understood that other embodiments may be utilized and that structural, logical and electrical changes may be made without departing from the scope of the present invention. The following description of example embodiments is, therefore, not to be taken in a limited sense, and the scope of the present invention is defined by the appended claims.

The functions or algorithms described herein may be implemented in software in one embodiment. The software may consist of computer executable instructions stored on computer readable media or computer readable storage device such as one or more non-transitory memories or other type of hardware based storage devices, either local or networked. Further, such functions correspond to modules, which may be software, hardware, firmware or any combination thereof. Multiple functions may be performed in one or more modules as desired, and the embodiments described are merely examples. The software may be executed on a digital signal processor, ASIC, microprocessor, or other type of processor operating on a computer system, such as a personal computer, server or other computer system, turning such computer system into a specifically programmed machine.

The functionality can be configured to perform an operation using, for instance, software, hardware, firmware, or the like. For example, the phrase “configured to” can refer to a logic circuit structure of a hardware element that is to implement the associated functionality. The phrase “configured to” can also refer to a logic circuit structure of a hardware element that is to implement the coding design of associated functionality of firmware or software. The term “module” refers to a structural element that can be implemented using any suitable hardware (e.g., a processor, among others), software (e.g., an application, among others), firmware, or any combination of hardware, software, and firmware. The term, “logic” encompasses any functionality for performing a task. For instance, each operation illustrated in the flowcharts corresponds to logic for performing that operation. An operation can be performed using, software, hardware, firmware, or the like. The terms, “component,” “system,” and the like may refer to computer-related entities, hardware, and software in execution, firmware, or combination thereof. A component may be a process running on a processor, an object, an executable, a program, a function, a subroutine, a computer, or a combination of software and hardware. The term, “processor,” may refer to a hardware component, such as a processing unit of a computer system.

Furthermore, the claimed subject matter may be implemented as a method, apparatus, or article of manufacture using standard programming and engineering techniques to produce software, firmware, hardware, or any combination thereof to control a computing device to implement the disclosed subject matter. The term, “article of manufacture,” as used herein is intended to encompass a computer program accessible from any computer-readable storage device or media. Computer-readable storage media can include, but are not limited to, magnetic storage devices, e.g., hard disk, floppy disk, magnetic strips, optical disk, compact disk (CD), digital versatile disk (DVD), smart cards, flash memory devices, among others. In contrast, computer-readable media, i.e., not storage media, may additionally include communication media such as transmission media for wireless signals and the like.

Current email clients, may provide email services for multiple accounts for a single user. In addition, users may have multiple different email clients, each with one or more accounts for different purposes. Some accounts may be personal accounts. Some personal accounts may be used for different hobbies. Other accounts may be work related. Different work accounts may be used for different clients, or for different responsibilities at work, such as different products or different roles or jobs within a work environment. It becomes very difficult to effectively manage and switch between different email accounts and clients. Combining accounts and/or clients can be confusing and unproductive.

For example, a first user may have one work account and multiple personal email accounts. A second user may be a business executive or an admin who manages multiple products. The second user may have multiple email accounts for each product along with a few personal email accounts. The first user may like to keep personal and work email accounts separate. The first user will then add either work or personal into a single email client but never both. The second user may prefer to keep the accounts related to each product separate, but that is not feasible with current clients.

Various embodiments of a new workspace management system provide the ability to use multiple workspaces. Each workspace may be configured to selectively handle one or more of several accounts of a client program and transfer such accounts between different workspaces. Each workspace can be assigned to multiple accounts to be viewed in a single view. The accounts may be associated with email hosting services in some embodiments. Generally, workspaces may be logical groupings of services and applications. Each workspace may be associated with a particular task or role of a user in some examples, allowing a user to quickly change sets of active or foreground services and applications as desired.

The new workspace management system provides the ability for users to group multiple email accounts under separate workspaces and provide a unified inbox view of the grouped accounts. The unified view may also include contacts, calendars, and tasks from different accounts. Users may quickly switch between each of these workspaces with a single mouse click, keyboard shortcut or voice commands. Thus, the first user described above may easily place their work account in one workspace and their multiple personal email accounts in a different workspace or workspaces. The second user described above may just as easily have a workspace containing their personal email account, and multiple workspaces where each workspace is dedicated to one or more of the separate product email accounts. These are just two examples of the flexibility and ease of navigation that may be provided by the workspace management system.

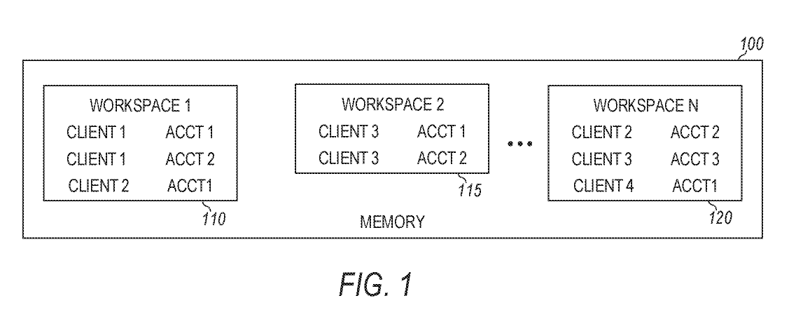

FIG. 1 is a block diagram logical representation of one or more workspace management tables in memory 100 that may be used to define and manage logical groupings of clients and accounts for different workspaces shown as workspace 1 at 110, workspace 2 at 115, and workspace N at 120. While three separate workspace management tables are illustrated, the tables may be combined in a single table in further embodiments, or otherwise to provide information utilized for managing and switching between workspaces.

While three workspaces are illustrated, there may be from two to N workspaces, where N may be well over 100, but limited by computing resource constraints. The logical representation may include a workspace identifier (ID), shown as workspace 1-N, client ID or IDs, and account ID or IDs associated with each account. As shown in memory space 100, accounts 1 and 2 of client 1 are in workspace 1 at 110, along with account 2 of client 2. Workspace 2 at 115 includes accounts 1 and 2 of client 3. Workspace 2 in one embodiment only includes accounts from client 3, which may correspond to multiple personal email accounts associated with a personal email client, such as Gmail or Outlook email programs. Workspace N at 120 includes account 2 of client 2, account 3 of client 3, and account 1 of client 4.

The workspace management system allows the first user to use two different workspaces, one workspace for all personal email accounts, regardless of email hosting service, and a different workspace for all work-related email accounts, again, regardless of email hosting service. Each workspace may provide a unified view of the email accounts within the workspace. The second user may easily utilize workspaces to organize email accounts for different products as desired. In one example, the second user may combine related product email accounts in respective workspaces, even if the accounts are under different email clients. Unified views of the emails from such accounts may be provided in each workspace.

The emails from the various accounts may be stored with an indication of the accounts to which the emails belong. The email may be stored in one or more databases accessible by their corresponding email hosting service provider and the email account utilized for each workspace. Such indications provide the ability to clearly associate each email with its respective original email hosting service provider, as well as allow the display of emails from multiple accounts in unified views corresponding to the various workspaces. The indications also allow for ease of transferring different email accounts between workspaces.

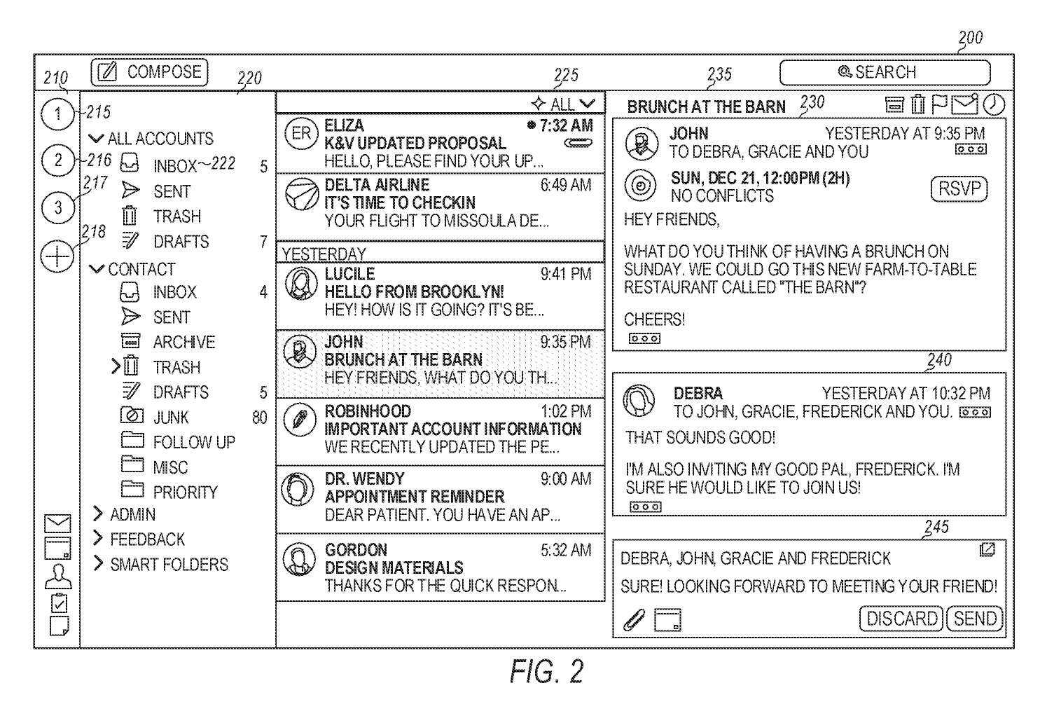

FIG. 2 is a representation of an example user interface 200 illustrating features of the workspace management system. Interface 200 includes a workspace bar 210 that shows multiple workspace selection icons 215, 216, and 217 that may be selected by a user to display a selected workspace. Icon 215 corresponds to a first workspace, labeled “1”. Icon 216 corresponds to a second workspace, labeled “2”, and icon 217 corresponds to a third workspace, labeled “3”. An add a workspace icon 218, shown as a “+” symbol, is selectable by the user to add more workspaces. Note that the labels are shown as numbers, but may also include images or other characters, including alphanumeric characters in further embodiments. The workspace bar 210 may be minimized and expanded by the user.

Icon 216 is shown as selected, and results in the display of the second workspace that in one embodiment includes a sidebar 220 showing a list of folders for the second workspace, with typical icons for selecting an inbox 222, sent, trash, and drafts under an all accounts folder. A contact folder includes an inbox, sent, archive, trash, drafts, junk, follow up, misc, and priority folders. Further folders include admin, feedback, and smart folders. In further embodiments other folders associated with the selected accounts in a selected workspace may be shown in the sidebar 220.

The display of the second workspace also includes a unified email or message list 225 that provides a list of multiple emails, such as emails from Eliza, Delta, Lucille, John, Robbinhood, Dr. Wendy, and Gordon for example due to inbox 222 being selected. In this example, the emails in the message list 225 for workspace 2 include both work and personal emails from the same or different email clients. The unified message list 225 includes mails from all the email accounts associated with the second workspace, sorted as selected by a user, such by date, subject, sender, etc. Emails from each account may be retrieved, combined, and sorted in accordance with the user's sorting selection and provided in a unified view comprising the message list 225.

The user in this example has selected the email from John at 227. User interface 200 in this embodiment shows the email from John in expanded form at 230 in a message detail view 235 of the interface 200. The message detail view 235 also shows email in an email thread, such as a response from Debra 240, and a draft of an email reply to multiple people by the user at 245.

Responsive to a user selecting a different workspace, both the folder list 220, the email sidebar, and the email display portion 235 will change to reflect the accounts in the selected workspace. Switching workspaces is as simple for a user as clicking or otherwise selecting the corresponding workspace icon 215. 216, or 217.

The second workspace is shown for example by an Outlook email client in FIG. 2. The Outlook email client is provided the emails from multiple email accounts in the second workspace and sorts them for display as shown in one embodiment. Note that the display may be customized by the user using the outlook email client to provide message previews or other of many different viewing modes as desired. While an Outlook email client may be used for the second workspace, a further workspace may utilize a different email hosting service provider, such as Gmail. Email from the email accounts in the further workspace will also be retrieved and sorted as specified by the Gmail client and displayed, also as specified by the Gmail client. Thus, switching workspaces may invoke different views and different email clients depending on user preferences or default email client preferences.

FIG. 3 is a flowchart illustrating a computer implemented method 300 of displaying a selected workspace in the foreground as the active workspace such that a user can interact with the workspace. At operation 310, a workspace selection is received. The selection is an indication identifying a first workspace from multiple workspaces, wherein each workspace is associated with at least one communication account, such as an email account, selected from multiple accounts associated with at least one of multiple communication clients. The selection may be the result of startup of the computer with a default workspace, or a selection of a new workspace by the user or otherwise received indication to change the active workspace.

At operation 320, a workplace management table is accessed to determine the list of applications and services to display in a display of the workspace. In further embodiments, the workspace may be simply stored in memory or storage, and retrieved for display. In other embodiments, the communication accounts are accessed and information from the multiple communication accounts associated with the selected workspace is retrieved at operation 330. The communications may then be aggregated from the multiple communication accounts into a unified view at operation 340 and displayed, made available for display, or transmitted for display at operation 350. The unified view may include communications from the multiple accounts that are sorted for proper display in the communication client utilized for the selected workspace to update the workspace display. The workspace display may be similar to that illustrated at 200 in FIG, 2.

The unified view may include indications, such as labeled icons, to show multiple workspaces for selection by a user. The icon labels may be various default colors, or colors selected by the user. The labels may also include one or more characters to help the user identify each workspace, such as W for work, W1 and W2 for different roles at work, or P for personal for example.

One or more of the workspaces may include one or more communication accounts from each of two or more communication clients. The communication accounts may be email accounts and the communication clients may be email clients.

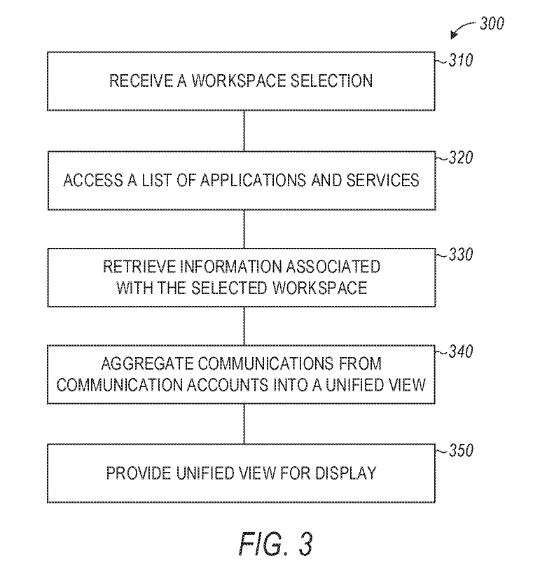

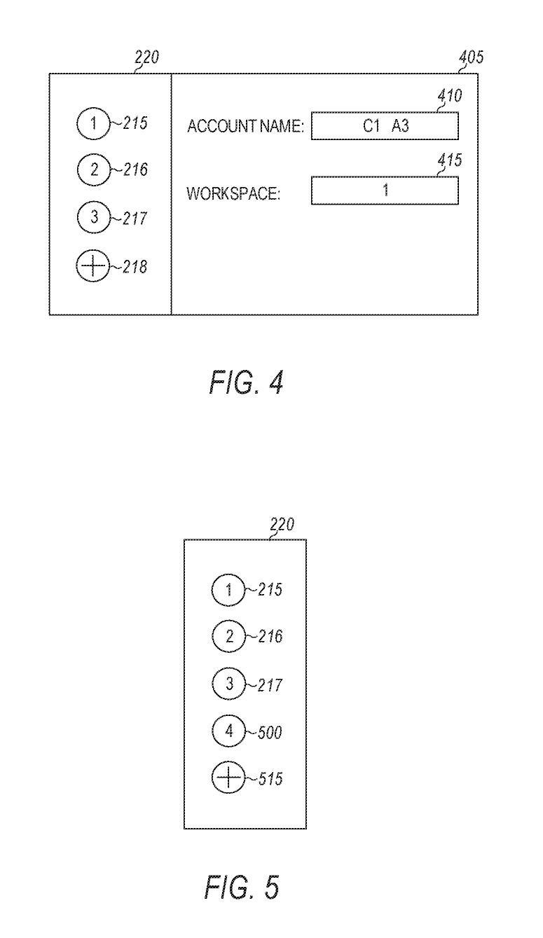

FIG. 4 at 400 illustrates a method of adding a new account to a workspace in an open new account user interface 405. Responsive to opening a new account, such as after naming the new account as indicated at new account field 410, a user may simple drag and drop the new account field 410 to one of the existing workspaces 215, 216, or 217. In one example, the user may drag and drop the new account field 410 to the add account icon 218, resulting in a new workspace being added to the workspace bar 220 as indicated in FIG. 5 at 500 and a new add workspace icon being added at 515 to the workspace bar 220. The new account in one example, is show as client 1, account 3, or C1 A3 for convenience. In a further example, a data entry field 415 may be used to enter the label of the workspace, shown there as workspace 1. In yet a further example, the new account may simply be added to a default workspace, such as workspace 1.

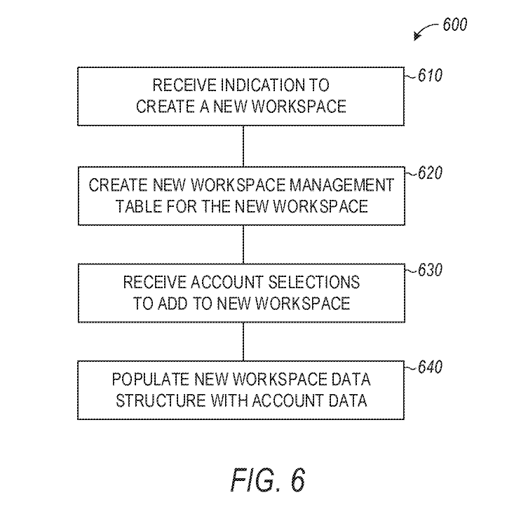

FIG. 6 is a flowchart illustrating a method 600 of creating a new workspace. Method 600 includes receiving an indication to create a new workspace at operation 610. The indication may be generated by a user clicking or otherwise electing the add workspace icon 218 illustrated in FIG. 2. The resulting workspace bar is shown at 220 in FIG. 5, with the new workspace icon indicated at 500 and labeled workspace 4. Note that a new add workspace icon is shown at 515.

The indication to create a new workspace may include a new name for the new workspace icon 218 which may be a default name, such a next character or characters in a sequence of characters, or simply a selected character or characters for each new workspace. A new workspace data structure, such as a workspace management table, is created at operation 620 for the new workspace and added to the stored workspace management tables in memory 100. At operation 630, one or more indications identifying one or more communication accounts to add to the new workspace are received. The workspace data structure is populated at operation 640 with data identifying the one or more communication accounts identified.

In one embodiment, the one or more of the communication accounts identified are from an existing workspace. The indication that identifies the one or more communication accounts to add to the new workspace may be generated responsive to a user dragging one or more account identifiers to the new workspace.

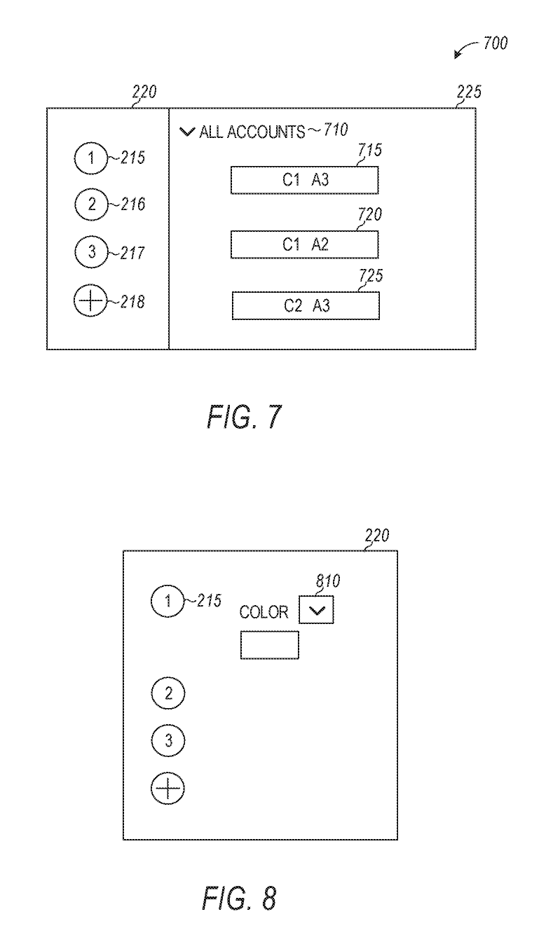

FIG. 7 is a graphical representation of a user interface 700 for moving accounts between workspaces. The workspaces are represented by icons 215, 216, and 217 in workspace bar 220. New workspace icon 218 is also illustrated. An “All Accounts” folder is shown at 710. In one example, the All Accounts folder has been selected by the user, such as by right clicking, keyboard shortcut, drop-down menu, or other means of selection. Such means may be used for all the selections in the various user interfaces described in various figures herein. The result is a list of accounts below the folder 710. The list of accounts includes client 1, account 1 at 715, client 1, account 2 at 720, and client 2 account 1 at 725, which is consistent with table 110 in FIG. 1 for the selected workspace 1 icon 215.

An account may be moved to a different workspace in one embodiment, by simply dragging and dropping the account representation to a different workspace representation. For instance, client 1, account 1 715 may be selected by use of a cursor and dragged to workspace 2 icon 216. Releasing the implement used to select and drag results in client 1, account 1 being removed from workspace 1, and added to workspace 2. Alternatively, the workspace management tables may be edited directly to change their configurations of accounts. Another alternative way to move an account includes right clicking on the account representation to generate a move to workspace option that lists available workspaces for selection. Clicking on one of such available workspaces moves the account to that workspace. In one embodiment, if all accounts are removed from a workspace, the workspace may be automatically deleted or otherwise removed. In further embodiment, the workspace icon may remain and be used for other accounts.

FIG. 8 illustrates an interface 800 for use in modifying the name and appearance of a workspace icon such as workspace icon 215 for example. Right clicking or otherwise selecting icon 215 for editing may result in a color selection interface with a drop-down menu or colors 810 being provided to allow a user to select a color for the icon. An editing field 820 may also be provided to enable the user to select one or more characters for the icon to be displayed with the icon. In further embodiments, a drop-down list of symbols, or a browsing option to search for images for use to display as the icon may be provided. While the workspace icons are shown as circles, any other shape, image, or one or more letters may be used as the icon in further embodiments.

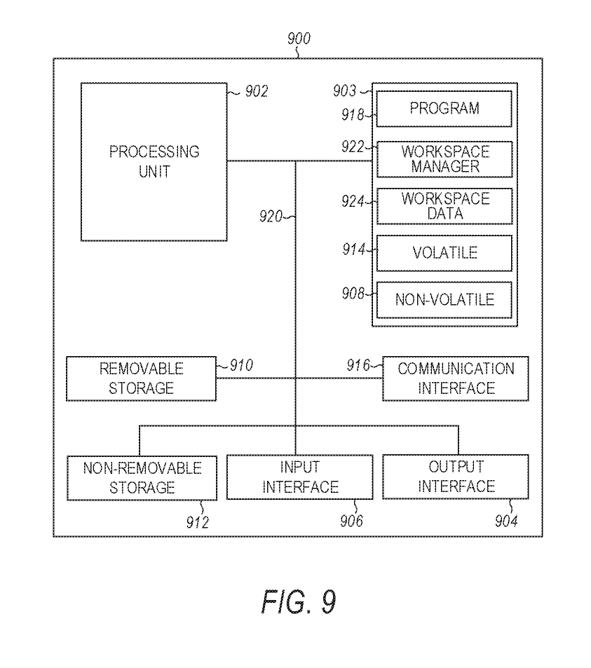

FIG. 9 is a block schematic diagram of a computer system 900 to implement and manage the use of flexible workspaces and for performing methods and algorithms according to example embodiments. All components need not be used in various embodiments.

One example computing device in the form of a computer 900 may include a processing unit 902, memory 903, removable storage 910, and non-removable storage 912. Although the example computing device is illustrated and described as computer 900, the computing device may be in different forms in different embodiments. For example, the computing device may instead be a smartphone, a tablet, smartwatch, smart storage device (SSD), or other computing device including the same or similar elements as illustrated and described with regard to FIG. 9. Devices, such as smartphones, tablets, and smartwatches, are generally collectively referred to as mobile devices or user equipment.

Although the various data storage elements are illustrated as part of the computer 900, the storage may also or alternatively include cloud-based storage accessible via a network, such as the Internet or server based storage. Note also that an SSD may include a processor on which the parser may be run, allowing transfer of parsed, filtered data through I/O channels between the SSD and main memory.

Memory 903 may include volatile memory 914 and non-volatile memory 908. Computer 900 may include—or have access to a computing environment that includes—a variety of computer-readable media, such as volatile memory 914 and non-volatile memory 908, removable storage 910 and non-removable storage 912. Computer storage includes random access memory (RAM), read only memory (ROM), erasable programmable read-only memory (EPROM) or electrically erasable programmable read-only memory (EEPROM), flash memory or other memory technologies, compact disc read-only memory (CD ROM), Digital Versatile Disks (DVD) or other optical disk storage, magnetic cassettes, magnetic tape, magnetic disk storage or other magnetic storage devices, or any other medium capable of storing computer-readable instructions.

Computer 900 may include or have access to a computing environment that includes input interface 906, output interface 904, and a communication interface 916. Output interface 904 may include a display device, such as a touchscreen, that also may serve as an input device. The input interface 906 may include one or more of a touchscreen, touchpad, mouse, keyboard, camera, one or more device-specific buttons, one or more sensors integrated within or coupled via wired or wireless data connections to the computer 900, and other input devices. The computer may operate in a networked environment using a communication connection to connect to one or more remote computers, such as database servers. The remote computer may include a personal computer (PC), server, router, network PC, a peer device or other common data flow network switch, or the like. The communication connection may include a Local Area Network (LAN), a Wide Area Network (WAN), cellular, Wi-Fi, Bluetooth, or other networks. According to one embodiment, the various components of computer 900 are connected with a system bus 920.

Computer-readable instructions stored on a computer-readable medium are executable by the processing unit 902 of the computer 900, such as a program 918. The program 918 in some embodiments comprises software to implement one or more communications clients, such as email clients and the email data associated with such clients. A workspace manager 922 implements management operations for maintaining the workspace tables and other workspace data as illustrated in memory block 924 according to any of the embodiments included herein. A hard drive, CD-ROM, and RAM are some examples of articles including a non-transitory computer-readable medium such as a storage device. The terms computer-readable medium and storage device do not include carrier waves to the extent carrier waves are deemed too transitory. Storage can also include networked storage, such as a storage area network (SAN). Computer program 918 along with the workspace manager 922 may be used to cause processing unit 902 to perform one or more methods or algorithms described herein.

### EXAMPLES

In example 1, a method of managing communication accounts includes receiving an indication identifying a first workspace from multiple workspaces, wherein each workspace is associated with at least one communication account selected from multiple accounts associated with at least one of multiple communication clients, retrieving information from multiple communication accounts associated with the first workspace, aggregating the information from the multiple communication accounts into a unified view, and causing display of the unified view.

Example 2 includes the method of example 1 wherein causing display of the unified view includes providing an interface having indications of the multiple workspaces for selection by a user.

Example 3 includes the method of any of examples 1-2 wherein the indications comprise icons labeled to identify each workspace.

Example 4 includes the method of any of examples 1-3 wherein wherein one or more workspaces include one or more communication accounts from each of two or more communication clients.

Example 5 includes the method of any of examples 1-4 wherein wherein the communication accounts comprise email accounts and wherein the communication clients comprise email hosting service providers.

Example 6 includes the method of any of examples 1-5 and further including receiving an indication of opening a new communication account and adding the account to a new, default, or existing workspace.

Example 7 includes the method of any of examples 1-6 and further including receiving an indication to create a new workspace, receiving a name for the new workspace, creating a data structure for the new workspace, receiving an indication identifying one or more communication accounts to add to the new workspace, and populating the data structure with data identifying the one or more communication accounts identified.

Example 8 includes the method of any of examples 1-7 wherein one or more of the communication accounts identified are from an existing workspace, and wherein the indication identifies the one or more communication accounts to add to the new workspace includes dragging an account identifier to the new workspace.

In example 9, a machine-readable storage device has instructions for execution by a processor of a machine to cause the processor to perform operations to perform a method of managing communication accounts. The operations include receiving an indication identifying a first workspace from multiple workspaces, wherein each workspace is associated with at least one communication account selected from multiple accounts associated with at least one of multiple communication clients, retrieving information from multiple communication accounts associated with the first workspace, aggregating the information from the multiple communication accounts into a unified view, and causing display of the unified view.

Example 10 includes the machine-readable storage device of example 1 wherein causing display of the unified view includes providing an interface having indications of the multiple workspaces for selection by a user.

Example 11 includes the machine-readable storage device of any of examples 9-10 wherein the indications comprise icons labeled to identify each workspace.

Example 12 includes the machine-readable storage device of any of examples 9-11 wherein one or more workspaces include one or more communication accounts from each of two or more communication clients and wherein the communication accounts comprise email accounts and wherein the communication clients comprise email hosting service providers.

Example 13 includes the machine-readable storage device of any of examples 0-12. wherein the operations further include receiving an indication of opening a new communication account and adding the account to a new, default, or existing workspace.

Example 14 includes the machine-readable storage device of any of examples 0-13 wherein the operations further include receiving an indication to create a new workspace, receiving a name for the new workspace, creating a data structure for the new workspace, receiving an indication identifying one or more communication accounts to add to the new workspace, and populating the data structure with data identifying the one or more communication accounts identified.

Example 15 includes the machine-readable storage device of any of examples 9-14 wherein one or more of the communication accounts identified are from an existing workspace, and wherein the indication identifies the one or more communication accounts to add to the new workspace includes dragging an account identifier to the new workspace.

In example 16, a device includes a processor and a memory device coupled to the processor and having a program stored thereon for execution by the processor to perform operations including receiving an indication identifying a first workspace from multiple workspaces, wherein each workspace is associated with at least one communication account selected from multiple accounts associated with at least one of multiple communication clients, retrieving information from multiple communication accounts associated with the first workspace, aggregating the information from the multiple communication accounts into a unified view, and causing display of the unified view.

Example 17 includes the device of example 1 wherein causing display of the unified view includes providing an interface having indications of the multiple workspaces for selection by a user wherein the indications comprise icons labeled to identify each workspace.

Example 18 includes the device of any of examples 16-17 wherein one or more workspaces include one or more communication accounts from each of two or more communication clients and wherein the communication accounts comprise email accounts and wherein the communication clients comprise email hosting service providers.

Example 19 includes the device of any of examples 16-18 wherein the operations further include receiving an indication of opening a new communication account, and adding the account to a new, default, or existing workspace.

Example 20 includes the device of any of examples 16-19 wherein the operations further include receiving an indication to create a new workspace, receiving a name for the new workspace, creating a data structure for the new workspace, receiving an indication identifying one or more communication accounts to add to the new workspace, populating the data structure with data identifying the one or more communication accounts identified.

Although a few embodiments have been described in detail above, other modifications are possible. For example, the logic flows depicted in the figures do not require the particular order shown, or sequential order, to achieve desirable results. Other steps may be provided, or steps may be eliminated, from the described flows, and other components may be added to, or removed from, the described systems. Other embodiments may be within the scope of the following claims.

1. A method of managing communication accounts, the method comprising:
receiving an indication identifying a first workspace from multiple workspaces, wherein each workspace is associated with at least one communication account selected from multiple accounts associated with at least one of multiple communication clients;
retrieving information from multiple communication accounts associated with the first workspace;
aggregating the information from the multiple communication accounts into a unified view; and
causing display of the unified view.

2. The method of claim 1 wherein causing display of the unified view includes providing an interface having indications of the multiple workspaces for selection by a user.

3. The method of claim 2 wherein the indications comprise icons labeled to identify each workspace.

4. The method of claim 1 wherein one or more workspaces include one or more communication accounts from each of two or more communication clients.

5. The method of claim 1 wherein the communication accounts comprise email accounts and wherein the communication clients comprise email hosting service providers.

6. The method of claim 1 and further comprising:
receiving an indication of opening a new communication account; and
adding the account to a new, default, or existing workspace.

7. The method of claim 1 and further comprising:
receiving an indication to create a new workspace;
receiving a name for the new workspace;
creating a data structure for the new workspace;
receiving an indication identifying one or more communication accounts to add to the new workspace; and
populating the data structure with data identifying the one or more communication accounts identified.

8. The method of claim 7 wherein one or more of the communication accounts identified are from an existing workspace, and wherein the indication identifies the one or more communication accounts to add to the new workspace includes dragging an account identifier to the new workspace.

9. A machine-readable storage device having instructions for execution by a processor of a machine to cause the processor to perform operations to perform a method of managing communication accounts, the operations comprising:
receiving an indication identifying a first workspace from multiple workspaces, wherein each workspace is associated with at least one communication account selected from multiple accounts associated with at least one of multiple communication clients;
retrieving information from multiple communication accounts associated with the first workspace;
aggregating the information from the multiple communication accounts into a unified view; and
causing display of the unified view.

10. The machine-readable storage device of claim 9 wherein causing display of the unified view includes providing an interface having indications of the multiple workspaces for selection by a user.

11. The machine-readable storage device of claim 10 wherein the indications comprise icons labeled to identify each workspace.

12. The machine-readable storage device of claim 9 wherein one or more workspaces include one or more communication accounts from each of two or more communication clients and wherein the communication accounts comprise email accounts and wherein the communication clients comprise email hosting service providers.

13. The machine-readable storage device of claim 9 wherein the operations further comprise:
receiving an indication of opening a new communication account; and
adding the account to a new, default, or existing workspace.

14. The machine-readable storage device of claim 9 wherein the operations further comprise:
receiving an indication to create a new workspace;
receiving a name for the new workspace;
creating a data structure for the new workspace;
receiving an indication identifying one or more communication accounts to add to the new workspace; and
populating the data structure with data identifying the one or more communication accounts identified.

15. The machine-readable storage device of claim 14 wherein one or more of the communication accounts identified are from an existing workspace, and wherein the indication identifies the one or more communication accounts to add to the new workspace includes dragging an account identifier to the new workspace.

16. A device comprising:
a processor; and
a memory device coupled to the processor and having a program stored thereon for execution by the processor to perform operations comprising:
receiving an indication identifying a first workspace from multiple workspaces, wherein each workspace is associated with at least one communication account selected from multiple accounts associated with at least one of multiple communication clients;
retrieving information from multiple communication accounts associated with the first workspace;
aggregating the information from the multiple communication accounts into a unified view; and
causing display of the unified view.

17. The device of claim 16 wherein causing display of the unified view includes providing an interface having indications of the multiple workspaces for selection by a user wherein the indications comprise icons labeled to identify each workspace.

18. The device of claim 16 wherein one or more workspaces include one or more communication accounts from each of two or more communication clients and wherein the communication accounts comprise email accounts and wherein the communication clients comprise email hosting service providers.

19. The device of claim 16 wherein the operations further comprise:
receiving an indication of opening a new communication account; and
adding the account to a new, default, or existing workspace.

20. The storage device of claim 16 wherein the operations further comprise:
receiving an indication to create a new workspace;
receiving a name for the new workspace;
creating a data structure for the new workspace;
receiving an indication identifying one or more communication accounts to add to the new workspace; and
populating the data structure with data identifying the one or more communication accounts identified.
